(19) United States
(12) Patent Application Publication
(10) Pub. No.: US 2026/0241607 A1
(43) Pub. Date: Aug. 20, 2026

(54) METHOD FOR USING REPLACEABLE NON-STICK SHEETS TO PREVENT WOOD-BASED COMPOSITE PANELS STICKING TO PRESS PLATENS

(71) Applicant: LOUISIANA-PACIFIC CORPORATION, NASHVILLE, TN (US)

(72) Inventors: JAMES P. LOTITO, LEASBURG, NC (US); JIANWEN NI, FRANKLIN, TN (US); DAVID LUCAS, SOUTH BOSTON, VA (US); GUY BARDWELL, MINITONAS (CA)

(21) Appl. No.: 19/368,775

(22) Filed: Oct. 24, 2025

Related U.S. Application Data
(60) Provisional application No. 63/711,282, filed on Oct. 24, 2024.
(60) Provisional application No. 63/711,274, filed on Oct. 24, 2024.

(51) Int. Cl. B27N 3/18; B27N 3/00; B27N 3/04; B27N 3/20

(52) U.S. Cl. CPC B27N 3/186; B27N 3/002; B27N 3/04; B27N 3/203

(57) ABSTRACT

A system for the mounting and use of replaceable non-stick screens or sheets on hot press platens for use during the pressing and manufacturing of wood-based composite panels that contain pMDI or other adhesives, additives or materials. The non-stick screens or sheets prevent the pMDI or other adhesives, additives or materials from adhering or sticking to a platen face, or otherwise causing sticking issues with the platen faces. The non-stick sheets include, but are not limited to, polytetrafluoroethylene (PTFE) coated fiberglass sheets, polyethylene terephthalate (PET) films, carbon fiber sheets, and ceramic coated sheets.

This application claims benefit of and priority to U.S. Provisional Applications No. 63/711,282, filed Oct. 24, 2024, and No. 63/711,274, filed Oct. 24, 2024, both of which are incorporated herein in their entireties by specific reference for all purposes.

### FIELD OF INVENTION

This invention relates to a method and related apparatus for using replaceable sheets with a tensioning system mounted on a press to prevent wood-based composite panels sticking to press platens, particularly with polymeric methylene diphenyl diisocyanate (pMDI) used as an adhesive for manufacturing wood-based composite panels.

### BACKGROUND OF THE INVENTION

Polymeric methylene diphenyl diisocyanate (pMDI) is commonly used as an adhesive for manufacturing wood-based composite panels. Due to pMDI's chemical reactivity, when pMDI being used in the surface layers of the panels, a release agent is typically used to prevent panels sticking to the press platens.

In some instances, other additives may be added to impart additional properties to the wood-based composites, such as water resistance, fire resistance, and fungal resistance. Some of these additives could cause panel sticking to press platens in a similar fashion to pMDI, and thus also require the use of a release agent.

A good distribution of release agents on the mat surface is critical to the release performance. The release agent application system also needs to be monitored, and the spray application of release agents requires industrial hygiene monitoring to ensure employee safety. In addition, some of the release agents can cause the darkening of panel color.

Accordingly, what is needed is a method of and a system for preventing mat and panel surfaces sticking to press platens without the issues involved with the use of release agents.

### BRIEF DESCRIPTION OF THE DRAWINGS

FIG. 1 shows a top perspective view of a non-stick sheet, with tensioning system components and mechanical hanger system components.

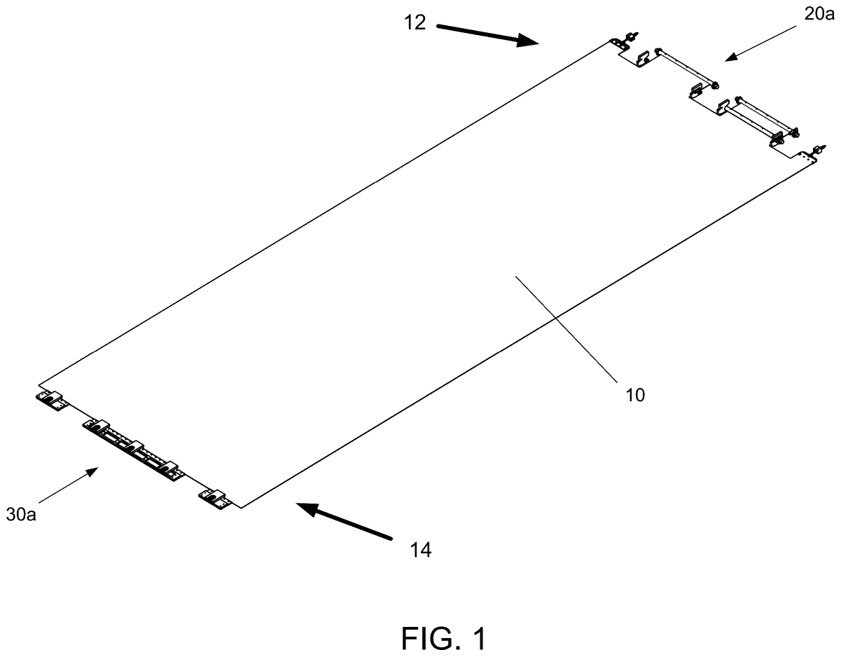

FIG. 2 shows a detailed view of the tensioning system components.

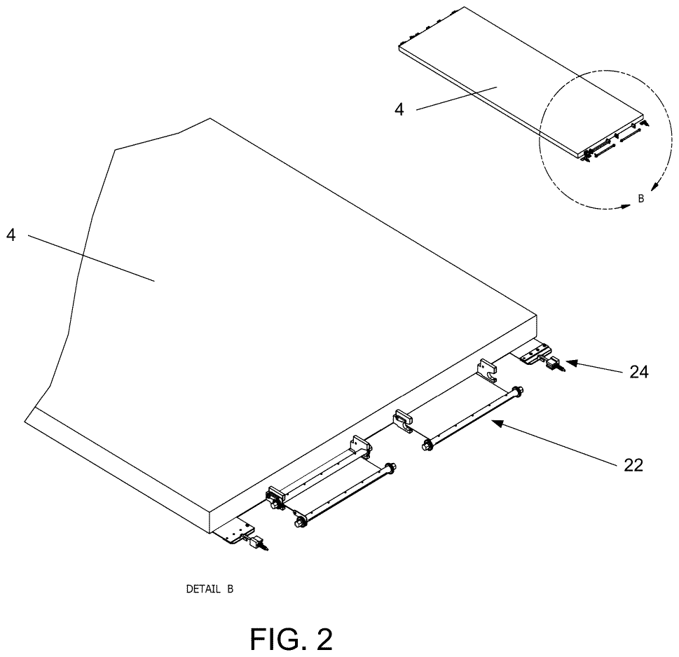

FIG. 3 shows a detailed view of the tensioning end of the non-stick sheet with tensioning system components.

FIG. 4 shows a detailed view of the toothed ratchet wheel, pawl and anti-rollback catch of Figure.

FIG. 5 shows a detailed view of the machine hanger system components.

FIG. 6 shows a detailed view of the hanger end of the non-stick sheet with hanger system components.

FIG. 7 shows a side view of the hanger end of the non-stick sheet with hanger system components.

### BRIEF DESCRIPTION OF INVENTION

In various exemplary embodiments, the present invention comprises the mounting and use of replaceable non-stick screens or sheets 10 with press platens 4 for use during the pressing and manufacturing of wood-based composite panels that contain pMDI or other adhesives, additives or materials that may cause sticking issues with the platen faces 6. The non-stick sheets 10 described herein include, but are not limited to, polytetrafluoroethylene (PTFE) coated fiberglass sheets, polyethylene terephthalate (PET) films, carbon fiber sheets, and ceramic coated sheets.

In the exemplary embodiment seen in the figures, the non-stick screens or sheets 10 are hung or suspended from the upper or top press platen 4 through a mechanical hangers and tensioning system, which is bolted onto the top press platen and is configured to mate with mounting components 20a, 30a on the corresponding ends of the non-stick sheet 10. Prior to pressing, a non-stick sheet 10 is connected (via a plurality of rivets, bolts, screws or similar fasteners inserted through corresponding holes near the ends of the sheet) to the tensioning system 20 on the loader (loading) side 12 of the press, and then rolled out or extended across the face of the press platen 6. The non-stick sheet is then hung from the unloader (unloading) side 14 of the press platen via a mechanical hanger system 30 bolted onto the platen 4.

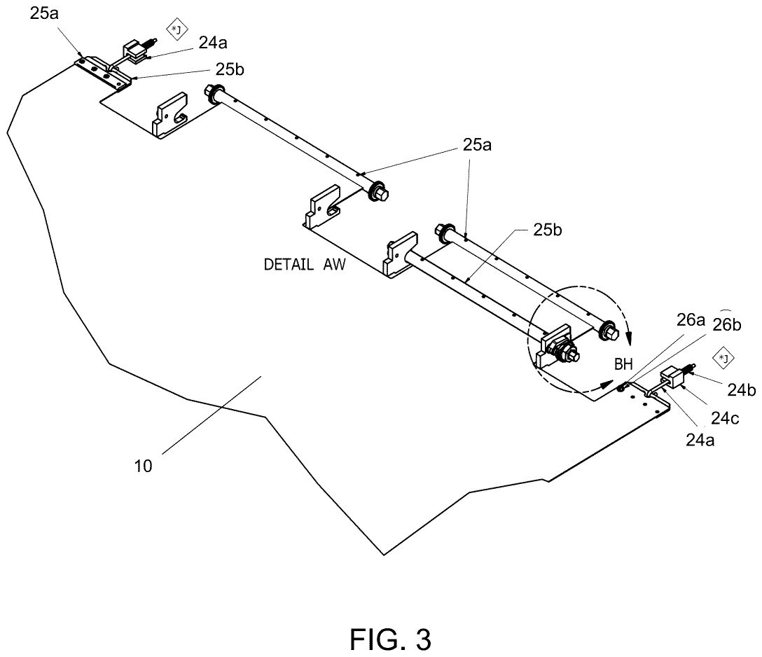

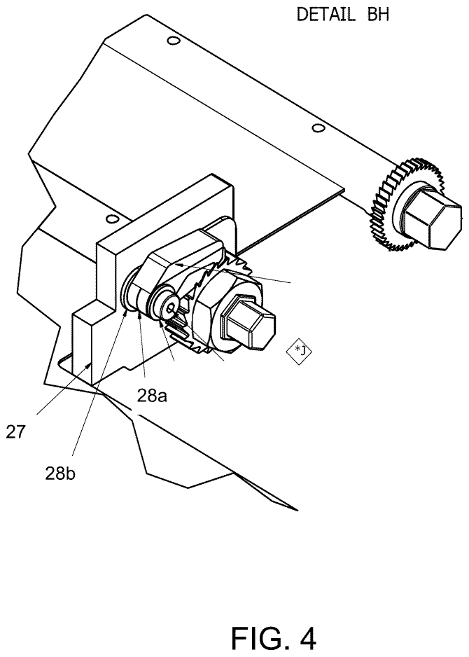

The tensioning system 20 allows the non-stick sheet 10 to be adequately tensioned to allow for minimal slack with respect to the platen face. In the exemplary embodiments shown in the figures, the profile of the loader end of the sheet comprises a plurality of extensions or tabs that connect to corresponding centrally-disposed tension rods and/or tension rod weldments 22a,b or J-hooks 24a with die springs 24b on the corners of the sheet. The ends of the J-hooks fit a corresponding hole in one or more mounting plates 25a,b mounted on corresponding extensions or tabs of the sheet and affixed by means of rivets, screws, bolts, washers or similar fasteners 26a,b) on one or more mounting plates 34a,b. The pair of J-hooks fit inside a corresponding C-holder slot 24c, and are used to assist in tensioning along the corners and edges of the sheet 10. The tension rods and/or tension rod weldments are part of a ratcheting system, with a toothed ratchet wheel, pawl 28a and anti-rollback catch 28b, as seen in FIGS. 3-4 (detail “BH”)) One or more of the tension rods and/or tension rod weldments are mounted on press tensioning capture plates 27 affixed to the side of the press platen.

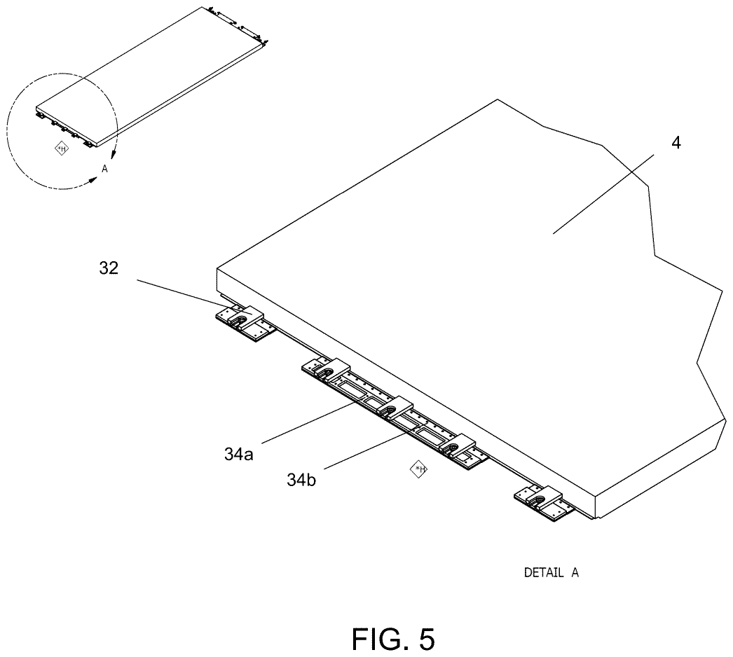

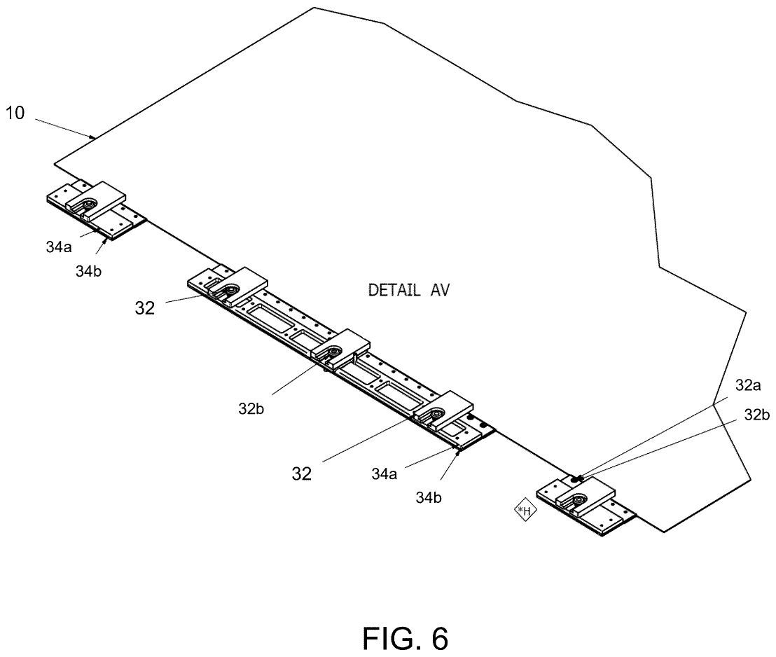

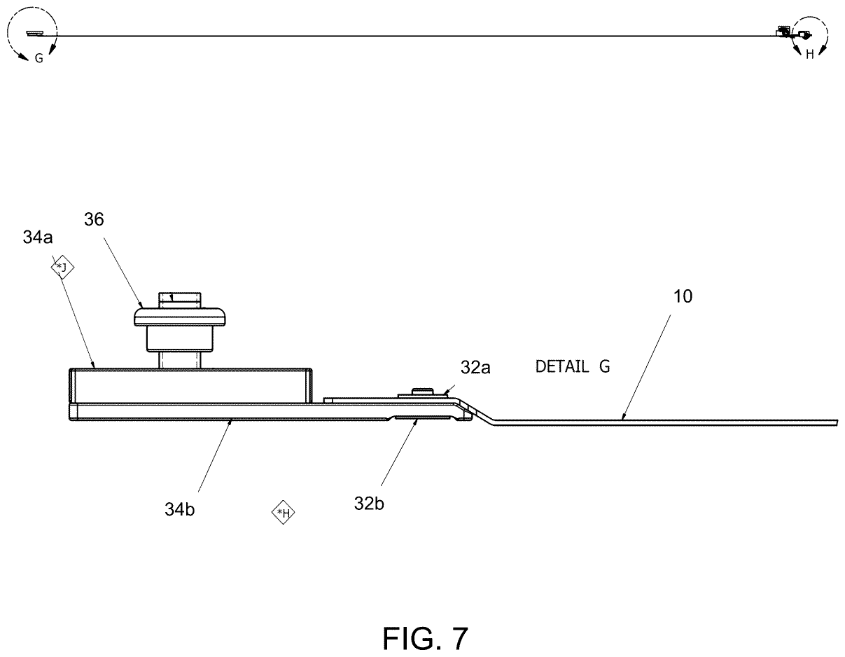

As seen in FIGS. 5-7, the mechanical hanger system 30 comprises a plurality of press hanger brackets 32 extending from or mounted on the side of the press platen 4. The end of the non-stick sheet 10 is affixed and mounted (by means of rivets, screws, nuts, washers or similar fasteners 32a,b) on one or more mounting plates 34a,b, which comprise one or more “mushroom cap” hangers 36, which fit in corresponding slots 32b in the corresponding press hanger brackets 32.

In other exemplary embodiments, different numbers and different placements of mounting plates, brackets, or the like may be used. Further, different attachment mechanisms or systems may be used to suspend or attach the non-stick sheets to the platens. The non-stick sheets are replaceable, and can be replaced after each pressing, after a pre-set number of presses, a period of time, or upon the presence of a certain amount of material build-up on the sheet.

The thickness of the non-stick sheets may range from approximately 0.05 to approximately 1.0 mm, preferably from 0.15 mm to 0.5 mm. Thicker sheets provide better durability of the sheet, but heat transfer is slower, which may cause slower production rates of the wood-based composite panels.

Accordingly, a system for producing a wood-based composite panel in accordance with the present invention comprises:
a heated press machine with a plurality of platens comprising at least one upper platen and at least one lower platen, configured to apply pressure and/or heat in a pressing process to convert a lignocellulosic mat placed between said upper platen and said lower platen into a wood-based composite panel, said heated press machine comprising a loading end and an unloading end; and
a non-stick sheet mounted on an underside of said upper platen;
wherein the lignocellulosic mat comprises a plurality of lignocellulosic elements and one or more adhesives mixed or blended with said lignocellulosic elements; and
wherein the non-stick sheet is configured to prevent said one or more adhesives from sticking or adhering to a lower face of said upper platen.

The heated press machine may be a multilevel or multilayer press machine. The non-stick sheet may be configured to prevent the strand mat and/or wood-based composite panel from sticking or adhering to a lower face of said upper platen. The non-stick sheet is mounted on the underside of said upper platen at the loading end and at the unloading end. The non-stick sheet may be mounted to the upper platen at the loading end by a mechanical tensioning system, and at the unloading end by a mechanical hanger system, wherein the mechanical tensioning system comprises one or more mounting plates removably fastened to the loading end of the non-stick sheet and removably connected to corresponding press tensioning capture plates fastened to the loading end of the upper platen, and the mechanical hanger system comprises one or more mounting plates fastened to the unloading end of the non-stick sheet and removably connected to corresponding press hanger brackets fastened to the unloading end of the upper platen. The one or more adhesives may comprise polymeric methylene diphenyl diisocyanate (pMDI). In several embodiments, the plurality of lignocellulosic elements comprise wood strands, and the wood-based composite panel comprises an oriented-strand board (OSB) panel. The non-stick sheet is replaceable, and may be replaced after a set number of press cycles, or after passage of a predetermined period of time. The non-stick sheet comprises a polytetrafluoroethylene (PTFE) coated fiberglass sheet, a polyethylene terephthalate (PET) film sheet, a carbon fiber sheet, or a ceramic coated sheet.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for producing a wood-based composite panel, comprising:
a heated press machine with a plurality of platens comprising at least one upper platen and at least one lower platen, configured to apply pressure and/or heat in a pressing process to convert a lignocellulosic mat placed between said upper platen and said lower platen into a wood-based composite panel, said heated press machine comprising a loading end and an unloading end; and
a non-stick sheet mounted on an underside of said upper platen;
wherein the lignocellulosic mat comprises a plurality of lignocellulosic elements and one or more adhesives mixed or blended with said lignocellulosic elements; and
wherein the non-stick sheet is configured to prevent said one or more adhesives from sticking or adhering to a lower face of said upper platen.

2. The system of claim 1, wherein the non-stick sheet is mounted on the underside of said upper platen at the loading end and at the unloading end.

3. The system of claim 2, wherein the non-stick sheet is mounted to the upper platen at the loading end by a mechanical tensioning system, and at the unloading end by a mechanical hanger system.

4. The system of claim 3, wherein the mechanical tensioning system comprises one or more mounting plates removably fastened to the loading end of the non-stick sheet and removably connected to corresponding press tensioning capture plates fastened to the loading end of the upper platen.

5. The system of claim 3, wherein the mechanical hanger system comprises one or more mounting plates fastened to the unloading end of the non-stick sheet and removably connected to corresponding press hanger brackets fastened to the unloading end of the upper platen.

6. The system of claim 1, wherein the one or more adhesives comprise polymeric methylene diphenyl diisocyanate (pMDI).

7. The system of claim 1, wherein the plurality of lignocellulosic elements comprise wood strands.

8. The system of claim 1, wherein the wood-based composite panel comprises an oriented-strand board (OSB) panel.

9. The system of claim 1, wherein said non-stick sheet comprises a polytetrafluoroethylene (PTFE) coated fiberglass sheet, a polyethylene terephthalate (PET) film sheet, a carbon fiber sheet, or a ceramic coated sheet.

10. The system of claim 1, wherein said heated press machine comprises a multilevel or multilayer press machine.

11. The system of claim 1, wherein the non-stick sheet is replaceable.

12. The system of claim 11, wherein the non-stick sheet is replaced after a set number of press cycles, or after passage of a predetermined period of time.

13. The system of claim 1, wherein the non-stick sheet has a thickness ranging from approximately 0.05 mm to approximately 1.0 mm.

14. The system of claim 1, wherein the non-stick sheet has a thickness ranging from 0.15 mm to 0.5 mm.

15. The system of claim 1, wherein the non-stick sheet is configured to prevent the wood-based composite panel from sticking or adhering to a lower face of said upper platen.
